(19) United States
(12) Patent Application Publication
(10) Pub. No.: US 2009/0234763 A1
(43) Pub. Date: Sep. 17, 2009

(54) HOME OPTION CONTRACT BUSINESS PROCESS

(75) Inventors: Robert E. Stenson, El Segundo, CA (US); Gregory T. Rickard, El Segundo, CA (US)

Correspondence Address: STEPTOE & JOHNSON LLP, 2121 AVENUE OF THE STARS, SUITE 2800, LOS ANGELES, CA, 90067, US

(73) Assignee: Equassure, Inc., a Delaware corporation, El Segundo, CA (US)

(21) Appl. No.: 11/840,193

(22) Filed: Aug. 16, 2007

Related U.S. Application Data
(60) Provisional application No. 60/847,526, filed on Sep. 27, 2006.

(51) Int. Cl. G06Q 40/00

(52) U.S. Cl. 705/35

(57) ABSTRACT

A method of protecting individual homeowners against a decline in the market value of their specific home during a term which has the steps of defining a strike price, defining a term, designating a surety to purchase the home and providing the homeowner with a unilateral right to sell the real property to the surety at the strike price during the term. The option may include a provision that the home will be purchased within a predetermined amount of time after receiving the notice of exercise of the option from the homeowner. The term may be for any period of time on which the parties agree, although the basic term shall be for as long as the homeowner owns the home. The option may be renewable if for less than as long as the homeowner owns the home. In most but not all cases, the strike price shall be the price at which the home would appraise at the time the option commences. The option shall also include a lock-out period at the beginning of the term during which the homeowner may not exercise the option. In conjunction with the option of homeowner to sell their real property to a surety, additional protection from foreclosure may be offered to the lender in the form of providing the lender with a unilateral right to sell the loan secured by the real property to the surety in the event that the lender records a Notice of Default the real property covered by the option.

### RELATED APPLICATIONS

This application is related to Provisional U.S. Patent Application No. 60/847,526, filed Sep. 27, 2006 by Robert Stenson, from which this application claims priority and which is incorporated by reference herein.

### BACKGROUND OF THE INVENTION

The purchase of a house is one of the most significant events in an individual's life. A house typically represents the most expensive purchase a person makes, and frequently constitutes the single greatest asset of a homeowner. The related home mortgage similarly represents the single greatest liability of the average homeowner. Because of the leveraging involved in most home acquisitions, any change in value of the home is correspondingly magnified. That is, a 10% rise in the value of a home purchased with a loan of 80%, yields a 50% return to the homeowner on his or her down payment. Conversely, a 10% drop in the home value yields a 50% drop in the homeowner's equity investment.

The downside risk to a homeowner's net worth from a drop in his or her home's value can be enormous. On a larger scale, a down turn in the housing sector can dramatically and negatively impact the entire U.S. economy by reducing consumer confidence and thereby reducing consumer spending. As such, the issue of hedging against losses in the housing market has been studied by leading economists for more than thirty years. Dr. Robert J. Shiller and Dr. Karl E. Case of Yale University have been pioneers in this field both in studying various risks in the nation's housing markets as well as developing indexes and hedging mechanisms for sophisticated investors to mitigate these risks. However, relatively little has been done during those same thirty plus years to effectively protect the individual homeowner from a decline in the value of his or her particular home.

Drs. Case and Shiller are perhaps best known for the S&P/Case-Shiller Home Price Indexes (“CSI”) which were developed for tracking housing prices in twenty leading metropolitan markets in the United States. The CSI has become an industry standard for measuring the relative health of the housing market. The Chicago Mercantile Exchange (“CME”) recently introduced the CME Housing futures and options (the “CME-HFO”) based on the CSI. The CME-HFO are tied to a weighted average of the national and the individual CSI's for ten major metropolitan markets. The CME-HFO provide sophisticated investors with a derivative investment vehicle which can be used to invest in the appreciation of the housing market or to hedge against anticipated downturns in that market. An investor can participate in any anticipated appreciation in the broader housing market by purchasing a long position in the CME-HFO. Conversely, an investor can hedge against a projected downturn in the market by short selling the CME-HFO. The ultimate success of either investment strategy will depend on the performance of the underlying CSI to which the CME-HFO is tied. The nature of the CME-HFO makes them ill-suited for the individual homeowners to hedge their investment in their home because (i) the underlying index for the CME-HFO is tied to a much broader market than an individual homeowner's local market and (ii) these investments are highly leveraged and designed for sophisticated investors.

There have also been small-scale attempts in limited situations to protect homeowners from major losses during a downturn in prices in their local area. Oak Park, Ill., for example, instituted a community-based equity assurance program. Residents of Oak Park could participate in the program by signing up and paying an appraisal fee at the time of sign-up. The appraisal would establish the price of the house for purposes of any claims.

After an initial vesting period of 5 years, if the homeowner sold the home for a loss, he/she would be able to file a claim to recover 80% of their loss from the decline in value. No premiums were paid by participants because the program was funded by a property tax on all residents regardless of whether they elected to participate in the program. Claims were limited to losses (e.g. if the home was sold for less than the appraised value) that were not due to an extended decline in the Chicago metropolitan area. This, along with the extended vesting period, severely limited the types of claims that could be made under this program.

The City of Chicago subsequently initiated a similar program in 1990. Like the Oak Park program, the Chicago program only insured against losses due to a decline in neighborhood quality. A major limitation of these programs is that they only protect against a very specific and narrow category of price decline which is not necessarily relevant to most homeowners seeking to protect against general market declines. In addition, because the programs are funded through property tax assessments, 100% of the homeowners in the covered area pay into the program even though only 1-3% of the qualified residents choose to participate in it, thereby keeping the costs artificially low.

Because these programs had significant minimum vesting periods before a homeowner can make a claim (e.g. five years), the programs essentially freeze out the homeowner from making a claim during the very period that their investment is most at risk (e.g. within the first two to five years.) By including such a long vesting period, these programs only protect against long term or secular declines in housing prices, rather than the more typical cyclical price decline of one to seven years.

The Home Value Protection (“HVP”) program, was instituted in Syracuse, N.Y. in 2002. HVP was started by Home Headquarters, Inc. (“HHQ”) an affiliate of Neighborhood Reinvestment (“NR”), a public non-profit organization chartered by Congress to help revitalize the nation's distressed, older communities. Unlike the Oak Park and Chicago program, this program does not insure against a specific loss on a specific home but instead acts as a hedging device against generalized declines in the neighborhood. The program has a vesting period of three years before a homeowner can make a claim. Unlike Oak Park and Chicago, the individual homeowner pays a premium of about 1.5% of the appraised value of the home.

After the initial three year vesting period, upon the sale of the home, the owner can collect a “claim” equal to the percentage loss in the local market real estate index used for the program multiplied by the amount of the coverage (e.g. if the local market index dropped by 10%, the payout would equal 10% of the dollar amount of coverage purchased.) The State of New York insurance commissioner determined that HVP is not an insurance policy because any claim under an HVP is not, in his words, a happening of a fortuitous event in which the insured has a material interest that will be adversely affected by the happening of such event. In other words, because the timing of making such a claim remains totally within the control of the homeowner (i.e. the decision to sell the home) the triggering event cannot be considered a “fortuitous event.” Furthermore, the amount of any claim is based on the performance of an index, in which the homeowner does not have a material interest, and not the individual home. In fact, a holder of an HVP contract can make a “claim” upon the sale of his or her house even if the house appreciated in value provided that the index, at the time of sale, is below the level it was at when the HVP was purchased. Therefore, there is no direct correlation between the index and the value of the individual home.

Because the HVP is based on a local market index and not on the actual value of the home, while it may approximate and hedge against any loss incurred by the homeowner, it does not guarantee the value of the home or protect against a specific loss incurred by the homeowner. In fact, the homeowner could experience a loss on the sale of his/her home but have no claim or recovery if the local market index remained flat or appreciated.

Theoreticians have also conceptually proposed limited home price insurance policies. In a paper entitled, “Home Equity Insurance,” by Robert Shiller and Allan Weiss, Journal of Real Estate Finance and Economics (1999), 19(1): 21-47 (the “Shiller-Weiss Paper”), the authors proposed a policy triggered by a “life event,” such as moving to another city. These types of policies somewhat resemble traditional casualty insurance policies. The policy would have restrictions, such as excluding sales triggered by a move to a new home within a certain radius of the home being sold, or requiring a covered sale to be triggered by a change of job, illness, death, or some similar life changing event. Like a traditional casualty insurance policy, these types of policies would include a deductible of some amount so the homeowner would not be fully protected and a claim would not kick in until the deductible was satisfied.

This type of insurance requires the actual sale of the property to a third party in order to determine the amount of the loss. And it would only pay out to the homeowner in the event of some type of life-casualty necessitating the sale of the home. As stated above, such a policy would also generally include some type of deductible and as is typical with insurance policies, the higher the deductible, the lower the premiums.

The USPTO has also recently granted patents for two other programs that attempt to address the issue of hedging against the risk of declining home prices. Patent No. 20040158515 for Home Asset Value Enhancement Notes (“HAVENs”) was published on Aug. 12, 2004. This particular patent relates to a business process by which homeowners would pledge a portion of their equity interest in their home which would then be packaged with similar interests from other homes to be sold in the secondary investment market, much like mortgage backed securities (“MBS”). The homeowner would receive an upfront payment at the time he/she pledges his/her equity interest, thereby locking in the agreed upon value of that equity interest in exchange for granting the investors the right to share in any upside of that interest from the appreciation of the homeowner's residence. Although this particular hedging mechanism does not have any upfront cost to the homeowner (e.g. a premium similar to an insurance policy), the homeowner is in effect selling a portion of his/her home at the time the HAVEN is entered into, thereby forfeiting any upside appreciation with respect to the portion of their equity being pledged. Although HAVENs have the advantage of eliminating any up-front costs to homeowner, it offers only partial protection to the homeowner with respect to market declines unless the homeowner pledges 100% of his equity interest. However, pledging 100% of his equity interest, would in effect make the HAVEN the equivalent of the homeowner selling his/her home while maintaining (i) his/her right to occupy the home and (ii) his/her mortgage obligation.

The availability of this product is largely dependent on (i) major financial institutions acting as underwriters to package a basket of HAVENs for sale in the secondary markets and (ii) investors acceptance of HAVENs as an attractive investment vehicle. Acceptance of HAVENs by investors in the secondary market as in investment vehicle should influence the price of the HAVENs, which will, in turn affect the amount to be paid to homeowners for the equity interest being pledged. This has the potential of creating a material disparity (positive or negative) between the intrinsic value of the underlying property interest being pledged and the price paid to the homeowner for it (e.g. the market capitalization of a REIT may not accurately reflect the intrinsic value of the underlying real estate assets, leading to arbitrage opportunities.) This disparity between the pricing of the HAVEN and the intrinsic value of the equity interest being pledged is a further limitation to the equity protection being provided.

US Patent Publication No. 20060080228 for Home Equity Protection Contracts and Method for Trading Them was published on Apr. 13, 2006. The financial instrument that is described in this patent is called a “Home Equity Protection Product” (“HEP”). The HEP, in concept, is similar to the HVP being offered in Syracuse, N.Y. in that the homeowner purchases an HEP in exchange for a “cash settled financial instrument that is based on an underlying index or data point of similarly priced residential real estate properties or some other underlying factor impacting residential real estate.” A claim under the HEP can be triggered by a sale of the home or the expiration of the term (e.g. which could be designed to coincide with the expiration of the existing mortgage). At the time of the triggering event, if the underlying index is below the strike value, then the claim would be paid to the homeowner based on the percentage decrease in the index. If the home's value is above the strike value at the triggering event, there would be no claim and no pay-out to the homeowner, regardless of any loss realized by the homeowner. At the time of the publishing of the patent for the HEP, many of the details related to the HEP, such as the underlying index to be used and the mechanism for determining payouts, were yet to be determined and were instead described in terms of general concepts and possibilities. Like HAVENs, the inventor of the HEP also anticipates bundling the HEPs into securities that are similar to MBS's which could then be sold on the secondary markets to investors. Because the HEP is tied to an external and broader based index, it suffers from the same deficiency as the HVP in that the potential for and value of a claim by a homeowner is not directly tied to the homeowner's underlying asset but is instead being approximated by the performance of some underlying index, which could diverge significantly (from the homeowner's perspective) from the actual performance of their individual home.

The programs described above offer either (i) a limited insurance policy for a very specific type of loss based on a local market decline or (ii) a straightforward futures contract designed to hedge against declines in a specific real estate market index. The first scenario compensates the homeowner for a very specific and narrow category of potential loss from the sale of one's home. The second category is not even related to the homeowner's home except to establish the amount of the futures contract. Rather than insuring against limited types of losses or hedging against broad market declines, the embodiments of the present invention provide the homeowner with an easy to understand and easy to execute means of preventing any loss from the sale of his/her individual home.

### SUMMARY OF THE INVENTION

A method of protecting individual homeowners and their mortgage lenders against a decline in the market value of a homeowner's specific real property in the form of an enhanced put option (the “Option”). In one embodiment, the terms and conditions of the Home Option may include (i) defining the market value (the “Strike Price”) of the real property (the “Home”) at the time protection is initiated, (ii) establishing a term for the protection (the “Option Term”), (iii) establishing the cost of the protection (the “Option Price”), (iv) establishing a period at the beginning of the Option Term during which the Option cannot be exercised (the “Lockout Period”), (v) designating a named buyer for the Home (the “Surety”), and (vi) establishing the procedures for the owner of the Home (the “Homeowner”) to exercise the Option and sell their Home to the Surety. In addition, the Surety may offer to the mortgage lender (the “Lender”) a put option (the “Mortgage Put”) on the mortgage loan (the “Loan”) secured by any Home for which the Surety has already issued an Option. The terms and conditions of the Mortgage Put shall parallel those of the Option except that (i) the strike price for the Mortgage Put (the “Put Strike Price”) shall be the lesser of the then outstanding principal and interest balance of the Loan or the original principal balance of the Loan and (ii) the Mortgage Put may only be exercised by the Lender in the event that the Lender records a Notice of Default (“NOD”). The method also provides the Homeowner with a guarantee that the Home will be purchased by the Surety at any time during the Option Term, after the expiration of the Lockout Period, for the Strike Price within a specified period of time after the Option is exercised by the Homeowner, regardless of market conditions.

The step of providing a guarantee to the Homeowner may come in the following form: during the Option Term, the Homeowner shall have the unilateral right to exercise the Option requiring the Surety to purchase the Home for the Strike Price. Upon the exercise of the Option, the Surety shall have a predetermined period of time (established in the Option contract) to purchase the Home at the Strike Price in accordance with the terms of the Option.

The step of providing a guarantee to the Lender may come in the following form: during the term of the Mortgage Put, the Lender shall have the unilateral right to exercise the Mortgage Put requiring the Surety to purchase the Loan for the Put Strike Price. Upon the exercise of the Mortgage Put, the Surety shall have a predetermined period of time (established in the Mortgage Put contract) to acquire the Loan at the Put Strike Price in accordance with the terms of the Mortgage Put.

The Option Price may be determined based on a proprietary pricing model that will take into consideration multiple factors including, but not limited to: (i) the age of the Homeowner, (ii) the employment status of the Homeowner, (iii) the marital status of the Homeowner, (iv) the credit score of the Homeowner, (v) the age of the Home, (vi) the condition of the Home, including recent upgrades, (vii) whether the Home is a primary residence or secondary residence, (viii) the historical price trends within the local neighborhood, (ix) the sum of all encumbrances outstanding against the Home as a percentage of the Strike Price, (x) the Strike Price as a percentage of the sales price or appraised value of the Home, (xi) the Option Term, and (xii) the duration of the Lockout Period. The Strike Price may optionally be set at less than the Home's sales price or appraised value as a means of reducing the Option Price. As one example, the Strike Price might be set between 90% and 95% of the purchase price or appraised value of the Home.

The option price for the Mortgage Put may be determined using a variation on the proprietary pricing model for the Option.

The Option may include provisions providing for credits against the Strike Price for traditional sales and closing costs including but not limited to broker's commissions, title insurance premiums, escrow fees, inspection and fumigation costs and pro-rations. In addition, the Option may includes provisions for credits against the Strike Price for deferred maintenance or other repairs to bring the Home into compliance with the representations and warranties made by the Homeowner regarding the condition of the Home at the time the Option was entered.

The Homeowner or the party purchasing the Option (which may be different than the Homeowner) may be required to make one or more of the following representations and/or warranties: the Home is a primary or secondary residence of the Homeowner, the Home is in good condition, the Home will be used only for non-commercial purposes, the Home is not subject to liens or encumbrances other than as disclosed on a preliminary title report (“PTR”), the Homeowner will not further encumber the Home without the consent of Surety and/or that all encumbrances against the Home will not exceed a predefined percentage of the Strike Price.

Variations on the option concept within the Option may be implemented. For example, an inflation protection mechanism may be offered to a Homeowner during the Option Term for an additional fee if the Home has appreciated since the effective date of the Option. A home equity line of credit (“HELOC”) may also be established in conjunction with the Option, up to a percentage of the Strike Price. Payment to a Homeowner may be made in the form of a reverse mortgage as opposed to a cash settlement, which may be based, for example, on a standard loan to value ratio. In cases where the Option Price is significant, the Homeowner may be permitted to finance the Option Price and pay it over time or roll it into a new home mortgage or HELOC.

The Surety may establish a reserve fund from a portion of the total Option Price for the Option and, if applicable, the Mortgage Put which will then be invested in various investment vehicles. The allocation between investment vehicles is typically determined based on factors such as projected return, liquidity, security, and relationship of such investment vehicles' performance to the performance of the respective housing markets in which Options have been written. In addition, the Surety may bundle a diversified group of Options and/or Mortgage Puts for sale as a portfolio to institutional investors in the secondary market in exchange for such investors assuming the related contingent liabilities. After establishing a performance history, these diversified bundles of Options and Mortgage Puts may then be packaged, securitized and offered as an exchange tradable security for individual investors in a form that is comparable to a MBS. The Surety may also elect to obtain reinsurance or credit enhancements for the contingent liability of Homeowners exercising their Options or Lenders exercising their Mortgage Puts.

The foregoing and other objects and advantages of this invention will be apparent from the following more detailed description.

### BRIEF DESCRIPTION OF THE DRAWINGS

FIG. 1 is a block diagram illustrating steps in one embodiment of a home option contract process according to the present invention;

FIG. 2 is a block diagram illustrating steps in another embodiment of a home option contract process according to the present invention; and

FIG. 3 is a block diagram illustrating steps in another embodiment of a home option contract process according to the present invention.

FIG. 4 is a block diagram illustrating steps in another embodiment of a home option contract process according to the present invention.

### DETAILED DESCRIPTION OF THE PREFERRED EMBODIMENTS

The present invention relates to a method of protecting homeowners against a decline in the value of their individual home and delays in being able to sell their home in a down market while also protecting lenders from defaults on home mortgage loans leading to foreclosures that could result in the lenders taking possession of individual homes. An Option is written to cover a specific Home and to protect the Homeowner against a decline in value of that particular Home, irrespective of how the broader housing market is behaving at any given time. The Option also eliminates any “closing” risk to the Homeowner by guaranteeing that the Surety will close escrow and purchase the Home within a period of time specified in the Option contract (expected to generally be no more than sixty (60) days after the Option is exercised.) This method overcomes various problems and limitations with previous approaches to assist homeowners in hedging their investment in their home.

Through the supplemental feature of the Mortgage Put, the present invention may offer Homeowners some protection against foreclosure and the corresponding damage to their credit score resulting from such an event. By way of extension, the present invention can also protect mortgage lenders by providing secondary credit support for the mortgage and/or full repayment of the principal balance, thereby providing lenders with a mechanism to avoid taking ownership of a non-performing real estate asset and the associated costs with managing and disposing of it. This could reduce lender's credit risk and associated costs thereby reducing the costs to borrowers in the form of lower origination costs and/or interest rates which could in effect make the cost of the Option negligible to the Homeowner.

In one embodiment, the Option has an established Strike Price that will be the gross price at which the Surety will purchase the Home. The Surety sets the maximum Strike Price based on an established purchase price or an appraisal during the application period. However, the Homeowner may elect to set the Strike Price lower than the maximum Strike Price if the Homeowner wishes to reduce the Option Price (e.g. the higher the Strike Price and the closer it is to the full value of the Home, the higher the Option Price.) Once the Option Price is established, the Homeowner pays the Option Price in one lump sum to the Surety in exchange for the protection of the put Option for the term provided in the Option.

In one embodiment, the term of the Option would be for as long the Homeowner owns the Home, except for early termination under certain limited circumstances. However, in an alternative embodiment, the duration of the term could be reduced or limited at the election of the Homeowner in order to reduce the Option Price.

Unlike a traditional insurance policy, there is no fortuitous event that triggers a claim under the Option. Instead, the exercise of an Option is solely within the control of the Homeowner. If, after testing the market during the term of the Option, the Homeowner determines that he/she cannot sell his/her Home for a price higher than the Strike Price, or he/she believes that they cannot find a buyer to close escrow within his/her time constraints (e.g. the Homeowner must close escrow within 60 days to close escrow on their purchase of their new home), then he/she can exercise the Option and sell the Home directly to the Surety within the established time-frame and in accordance with the terms of the Option. The Surety would, at the close of escrow, pay off all of the approved liens against the Home, all related sales and closing costs and then any net proceeds to the Homeowner. This allows the Surety the option to turn around and sell the Home (and incur any loss immediately but reduce any further downside) or alternatively, hold the Home and lease it out until market conditions improve.

Options will generally be purchased by the Homeowner (either as part of a new home purchase or a refinancing). For many Homeowners the Option Price may be substantial relative to their annual income making the one-time up-front payment impractical. As a non-limiting example, assuming the Option Price is approximately 1.5% of a Strike Price of $500,000, the Homeowner would have to make a one-time up-front payment of $7,500. This may be too much for a Homeowner who is otherwise interested in the substantial benefits of the Option. To ameliorate this upfront cost for the Homeowner, one embodiment provides for the Option Price to be rolled into a traditional mortgage, provided there are sufficient proceeds from the Loan to pay the Option Price.

As another alternative embodiment, the Surety may offer the Lender supplemental mortgage protection in the form of a Mortgage Put. This would be a separate put option agreement purchased by the Lender from the Surety under which the Lender could unilaterally elect to convey the Loan to the Surety in the event the Lender records an NOD with respect to the Loan. Under this embodiment, upon the exercise of the option in the Mortgage Put, the Surety would acquire the Loan directly from the Lender for the established Strike Price upon the terms and conditions contained in the Mortgage Put and then would proceed to resolve the default directly with the Homeowner, most likely through an agreement under which the Homeowner elects to exercise the Option. The supplemental coverage from the Mortgage Put enables both the Homeowner and the Lender to enjoy guaranteed protection against a foreclosure.

As another alternative embodiment, the Surety may also provide the Homeowner with special financing of the Option Price, if the purchase of the Option is not part of a new home purchase or an existing home refinancing. If the Surety, or some alternative financing source, provides such financing, a deed of trust would be recorded against the Home for the full amount of the Option Price that is financed. In addition, at the time the Option is exercised, any outstanding balance due on the loan to finance the purchase of the Option would be paid off prior to distributing net proceeds to the Homeowner at the close of escrow.

By way of a non-limiting example, assuming a $7,500 Option Price was financed over a 10 year term at 10% per annum, this would work out to a monthly payment of $99.11 on a fully amortized basis, which is competitive for a consumer loan. The payment would be secured by a deed of trust against the Home and even though it would be lower in priority to the first mortgage and any other approved of encumbrances at the time the Option is purchased, priority would be irrelevant because the Strike Price would exceed the total of all approved monetary encumbrances against the Home. The unpaid balance would simply be a deduction from the sales proceeds paid to the Homeowner at the close of escrow upon the exercise of the Option.

By recording a deed of trust against the Home for the financed portion of the Option Price, it insures pay-off of the Option Price if the Homeowner sells the Home prior to the expiration of the Option and full payment of the Option Price.

If the Option is implemented as a straightforward put option on the individual Home of the Homeowner, the Option guarantees (i) a minimum sales price of that Home during the Option Term, (ii) ease of sale by avoiding the need to market the Home and (iii) close of escrow within a specified amount of time, regardless of market conditions. This is substantially different from and superior to insuring only against a loss upon an actual sale of the Home to a third party for less than the Strike Price. Under a claim type scenario as described in the previous sentence, the Homeowner still has the burden of marketing the Home to find a buyer as well as dealing with the uncertainty of when and if a selected buyer will close escrow. Even when escrow ultimately closes, the Homeowner would still face the added burden and delay of having to make a claim in order to get reimbursed for his/her loss.

Unlike the programs described in the Background section, the Option provides a loss prevention mechanism for the Homeowner as opposed to a loss mitigation or indemnification. Furthermore, the Option includes a performance and timing guarantee enabling the Homeowner to make definite plans with respect to the sale of his/her Home and the purchase of a new home in an otherwise uncertain market. The Option provides the Homeowner with this comprehensive protection in a form that is exhaustive in its coverage, easy to understand for the Homeowner, and in a form that can be readily integrated into a transaction that the Homeowner is already making (e.g. a new home purchase or existing home refinancing.)

Furthermore, this invention extends the benefits of the Option protector to the Lender through the supplemental coverage of a Mortgage Put. The Mortgage Put feature can substantially reduce the credit risk of the Loan to the Lender enabling the Lender to offer the Homeowner lower interest rates and reduce origination costs. By removing the risk of foreclosure to the Lender, it provides the Homeowner with the added benefit of potentially eliminating the negative impact of having a foreclosure show up on the Homeowner's credit history.

One approach according to the present invention consists of the following basic elements:

1. Option—The Option contract governing the terms and conditions under which the Homeowner can exercise the option to sell his/her house to the Surety.

2. Mortgage Put—the option contract governing the terms and conditions under which the Lender can exercise the option to sell the Loan to the Surety.

3. Originator—The entity that (i) underwrites, (ii) originates and (iii) services the Option and the Mortgage Put on behalf of the Surety during the Option Term.

4. Surety—The entity that undertakes the contingent liability of the Option or Mortgage Put being exercised and is required to purchase the Homeowner's Home if the Option is exercised or the Loan if the Mortgage Put is exercised. The Surety may or may not be the Originator and/or a subsidiary, affiliate or related entity of the Originator.

5. Homeowner—The individual homeowner who acquires the right to sell his/her Home to the Surety at the Strike Price during the Option Term in accordance with the terms and conditions thereof.

6. Home—The property that is the subject of the Option. It must be the primary or secondary residence of the Homeowner and not an investment property.

7. Option Term—The period of time during which (i) the Homeowner may exercise the Option to sell his/her home to the Surety and/or (ii) the Lender may exercise the option to sell the Loan to the Surety. The term will generally be for as long as the Homeowner owns the Home, subject to early termination under certain limited circumstances, but the Homeowner may elect a shorter term to reduce the Option Price.

8. Strike Price—The mutually agreed upon price at which the Surety shall purchase the Home from the Homeowner under the terms and conditions of the Option. The maximum Strike Price will be set by the Originator based on current market conditions and/or appraised value but the Homeowner may elect a lower Strike Price to reduce the Option Price.

9. Put Strike Price—The lesser of the outstanding principal balance and accrued interest of the Loan, not including late fees or other costs, at the time of exercise of the Mortgage Put or the original principal balance of the Loan.

10. Lock-out Period—A period to be determined by the Originator at the beginning of the Option Term during which the Homeowner may not exercise the Option to sell his/her home. The Lock-out Period will commence at the effective date of the Option and continue in effect to the time period defined in the Option to protect against Homeowners seeking to sell the Home at the time the Option is purchased. The Homeowner may elect to extend the Lock-out Period beyond the minimum period established by the Originator to reduce the Option Price. The Lock-out Period shall be the same for the Mortgage Put.

11. Option Price—The price to be paid to the Originator by the Homeowner at the commencement of the Option. The Option Price will be based on the Strike Price, the Option Term, the duration of the Lock-out Period and other criteria included in the Originator's proprietary underwriting model and assessment of risk that the Option will be exercised during the Option Term.

12. Mortgage Put Price—The price to be paid to the Originator by the Lender at the commencement of the Mortgage Put. The Mortgage Put Price will be based on the Strike Price, the Option Term, the duration of the Lock-out Period and other criteria included in the Originator's proprietary underwriting model and assessment of risk that the Mortgage Put will be exercised during the Option Term

13. Agents—Outside sales agents for the Originator who market and sell the Options to Homeowners and Mortgage Puts to the Lenders. Subject to complying with Originator's underwriting requirements and any other conditions contained in the agency agreement, Agents will be authorized to execute Options and Mortgage Puts on behalf of the Originator, that shall be binding on the Surety.

14. Servicers—Subsidiaries, affiliates and/or companies related to the Originator that shall provide support services including, but not limited to: brokerage (for purchases, sales and management of Homes), escrow, title insurance and home inspections. Servicers shall provide services traditionally associated with the purchase, sale and management of residential real property.

15. Lender—The company providing the mortgage on the Home to the Homeowner.

16. Loan—the mortgage loan provided by the Lender and secured by the Home.

17. Mortgage Default—A default by the Homeowner under his/her Loan that results in the Lender recording a NOD against the Home.

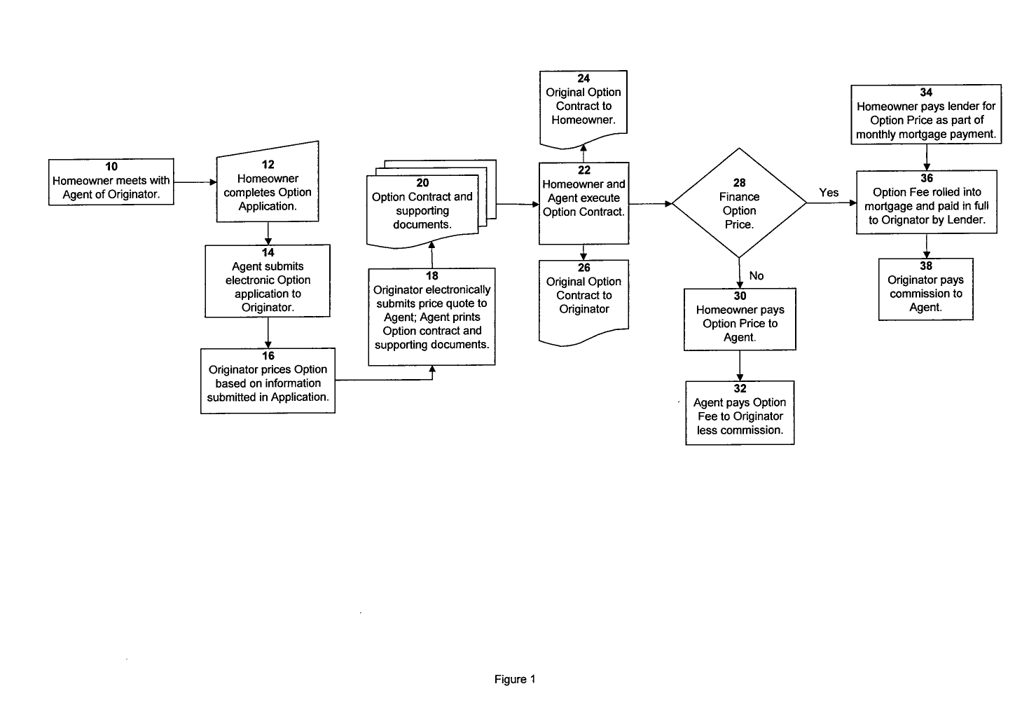

The following, non-limiting example will provide more specifics regarding a typical transaction, while FIGS. 1-4 generally illustrate three exemplary, non-limiting aspects of the protection provided by the Option and the Mortgage Put.

Considering one embodiment of an origination process as illustrated in FIG. 1, the Homeowner typically meets with an Agent of the Originator at 10. The Homeowner completes an Option application at 12. The Agent then typically submits an Option application in electronic form to the Originator at 14, although the application could alternatively be a traditional paper-based application. Upon receiving the application, the Originator prices the Option at 16 based on information submitted in the application. The Originator then submits a price quote to the Agent at 18, typically via electronic means such as a web-based portal, e-mail, fax, text message or the like. The Agent prints the Option contract and supporting documents, and assembles the Option contract and supporting documents.

The Homeowner and, optionally, the Agent then execute the Option contract at 22. One original option contract will typically go to the Homeowner at 24, while another original Option contract goes to the Originator at 26. It is noted here that paper-based applications, with physical signatures of the required party or parties is just one option. Other options, such as attaching electronic signatures to electronic documents, may alternatively be employed to execute documents. The documents may also be distributed electronically rather than physically, preferably when appropriate protocols and verification and security systems are in place.

The process may include an option at 28 with respect to payment of the Option Price. One option at 30 is for the Homeowner to pay the Option Price directly to the Agent. The Agent then pays the Option Price to the Originator, less a commission, at 32.

Another option at 34 is for the Homeowner to pay the lender for the Option Price as part of monthly mortgage payment. The Option Price is then rolled into a Loan at 36, and paid in full to the Originator by the Lender. The Originator then pays a commission to the Agent at 38.

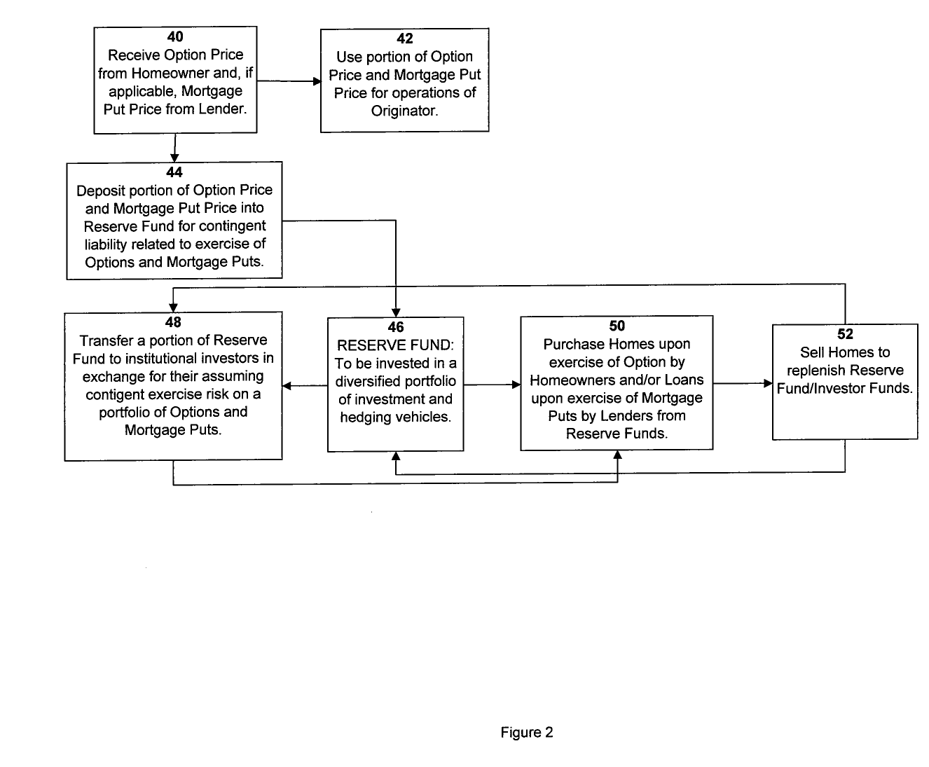

Now we turn to FIG. 2, which illustrates one embodiment of a capital management process according to the present invention. Once the Option Price and, if applicable, the Mortgage Put Price, is received from the Homeowner and Lender, respectively, at 40, a portion of the Option Price and the Mortgage Put Price are used for the operations of the Originator at 42. Another portion of the Option Price and Mortgage Put Price are deposited into the reserve fund for contingent liabilities related to exercise of Options and Mortgage Puts, at 44. The reserve fund is typically invested in a diversified portfolio of investment and hedging vehicles, at 46. A portion of the reserve fund may be transferred to institutional investors at 48, in exchange for their assuming contingent exercise risk on a portfolio of Option and/or Mortgage Put contracts. The reserve fund may also be used to purchase a Home or a Loan at 50 upon the exercise of an Option by a Homeowner or the exercise of a Mortgage Put by a Lender. The Home (which will ultimately be purchased by the Surety from the Homeowner if a Mortgage Put is exercised and the Loan is not paid off prior to a non-judicial foreclosure) is then sold at 52 to replenish the reserve fund and/or repay the institutional investors.

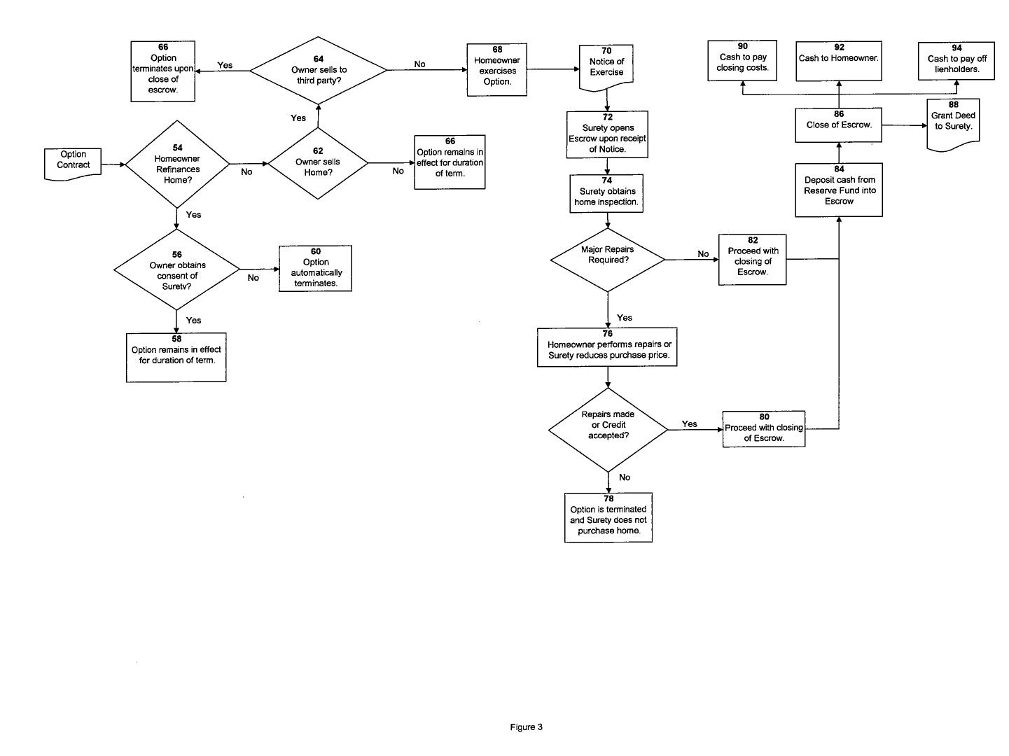

FIG. 3 illustrates one approach to termination/exercise of the Option contract. The Homeowner may choose to refinance the House at 54. If he/she does, the Homeowner may obtain the consent of the Surety at 56, in which case the Option remains in effect for the duration of the Option Term at 58. But if the consent of the Surety is not obtained, the Option automatically terminates at 60 upon the Homeowner refinancing the Home.

On the other hand, if the Homeowner does not refinance the House, the Homeowner may sell the Home at 62. If the Home is sold on the open market at 64, the Option automatically terminates upon the close of escrow at 66. Otherwise, the Homeowner exercises the Option at 68. The Homeowner provides notice of the exercise at 70. The Surety then opens Escrow at 72 upon receipt of the notice. The Surety obtains a home inspection at 74. If the inspection reveals that major repairs are required to restore the Home to the condition that was represented and warranted by the Homeowner at the time the Option was executed, the Homeowner may perform the necessary repairs specified in the inspection report. Otherwise, if the Homeowner elects not to make the repairs, the Surety may reduce the purchase price (i.e. the Strike Price) at 76 for the amount of the repairs. If repairs are not made, or the Homeowner does not accept the reduction in purchase price/credit proposed by the Surety, the Option is terminated and the Surety does not purchase the home at 78.

But if the repairs are made, or the Homeowner does accept the reduction in the purchase price/credit, the process then proceeds with closing of Escrow at 80. Similarly, if no major repairs are required, the process may also proceed with the closing of Escrow at 82.

To proceed with the closing of Escrow, cash from the reserve fund is deposited into Escrow at 84. At the close of Escrow at 86, a grant deed goes to the Surety at 88. Cash is dispersed to pay the closing costs at 90, to pay the Homeowner at 92, and to pay off any lien holders at 94.

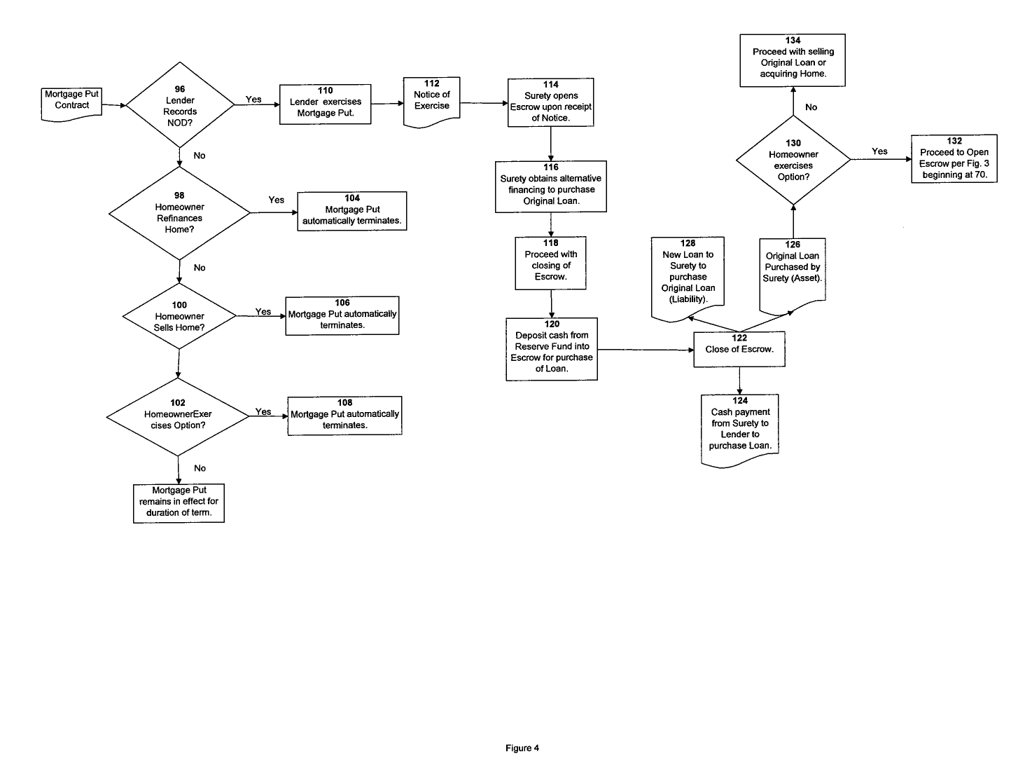

FIG. 4 illustrates one approach to the termination/exercise of the Mortgage Put contract. The Lender's right to exercise the Mortgage Put is triggered by the recording of a NOD by the Lender after the occurrence of a Mortgage Default. If an NOD is not recorded at 96, then the Mortgage Put remains in effect for the shorter of the term of the Mortgage Put or until such time as the Homeowner refinances the Home at 98, sells the Home at 100, or exercises the Option at 102. If the Homeowner refinances or sells the Home or exercises the Option, the Mortgage Put automatically terminates at 104, 106 and 108, respectively.

If, however, there is a Mortgage Default resulting in the recording of an NOD at 96, the Lender would exercise the Mortgage Put at 110 by sending the Surety notice of exercise at 112. Upon receipt of the notice of exercise of the Mortgage Put by the Lender, the Surety would open Escrow at 114. During the Escrow, the Surety would determine whether to purchase the Loan for cash from the reserve funds or arrange alternative financing at 116. The Surety would then proceed to closing the Escrow at 118 by depositing the necessary cash into escrow for the purchase of the Loan at 120.

The Escrow closes at 122 with the Put Strike Price being paid to the Lender at 124. At the closing, the Surety takes over the Loan becomes the Lender pursuant to the Loan at 126. The Loan would thereafter appear as an asset on the Surety's balance sheet, albeit a non-performing one. If the Surety financed the purchase of the Loan, the Surety would have a corresponding new loan at 128 in the amount borrowed to purchase the Loan. The new loan would then show up as a corresponding liability on the Surety's balance sheet.

Upon taking over the Loan, the Surety would then seek to have the Homeowner exercise the Option at 130 for the purpose of extinguishing the Loan and the Surety taking ownership of the House for later disposition through sale. If the Homeowner elects to exercise the Option at 132, the Surety would open a new Escrow and thereafter follow the procedures outlined in FIG. 3 beginning at 70.

If the Homeowner is unavailable (e.g. abandons the Home) or elects not to exercise the Option, the Surety would pursue all of its rights and remedies pursuant to the Loan at 134 to obtain repayment of the Loan, foreclose on the Home or sell the Loan to a third party.

Having considered in detail particular, non-limiting embodiments of the present invention, further consideration is now given to specific aspects, relating to the transaction, marketing, sales process, general terms and conditions, and alternative products.

### The Transaction

The Originator shall market and sell Options to the general public through a network of Agents and/or directly through a website or toll-free number. The Originator and/or one of its Agents shall write an Option contract under which the Homeowner will pay an agreed upon Option Price to the Originator in exchange for the Surety agreeing to purchase the Homeowner's Home for the agreed upon Strike Price upon a predetermined numbers of days of advanced written notice for up to as long as the Homeowner owns his/her home. In addition, if the Option is being purchased in conjunction with a Loan for a new purchase or refinancing of a Home, the Originator may offer the Lender supplemental default protection in the form of a Mortgage Put enabling the Lender to sell the Loan to the Surety in the event the Lender records an NOD with respect to the Loan secured by the Home covered by the Option. The Mortgage Put will have its own Mortgage Put Price and Put Strike Price but in most other ways will parallel the terms and conditions of the Option contract.

### Marketing

The Originator most likely will use multiple outlets to directly market the Option to the public including, but not limited to, mass media advertising (television, radio and print ads), telemarketing, direct mail, incoming call centers using toll-free numbers and a company website. In addition, the Originator may use individual independent Agents (Agents may include mortgage lenders, mortgage brokers, real estate agents, title insurance companies and estate planners) who can target their existing clients presenting the Option as a supplemental product to a home sale (as an incentive offered to buyers by sellers), home purchase, home refinancing, title insurance or estate plan (all as protection against a potential market downturn.)

The basic sales pitch will be to position the Option as a means of preventing any loss of a Homeowner's home value by providing the Homeowner with a guaranteed buyer at a guaranteed price upon the demand of the Homeowner, regardless of market conditions. The Option provides the Homeowner with the additional security of guaranteed performance (i.e. close of escrow) within a predefined period of time substantially improving the Homeowner's ability to plan any required relocation. Finally, through the supplemental Mortgage Put, the Homeowner and the Lender can obtain additional protection from foreclosure in the event of a Mortgage Default.

The pitch can be tailored to specific niches within the market depending on the ultimate purchaser (e.g. the Homeowner, home builder or a home seller) and the distribution channel (e.g. direct sale to consumer or through an Agent, including a mortgage company, real estate broker, title insurance company, estate planner.)

### Sales Process

The sales process may take place in any of a number of ways, including:

1. In Person—This will generally take place through an independent Agent such as a mortgage company, real estate broker, title company or estate planner. Typically, the Option will be offered by the independent Agent as an add-on to some other product or service being offered to the Homeowner by the agent (e.g. a new loan from a mortgage company, sale of a home by a real estate broker, title insurance policy being purchased from a title company, or an estate plan being prepared by an estate planner.)

2. Telephone—This would take place by a Homeowner responding to a mass-media or direct mail advertising campaign by calling a toll-free number. A knowledgeable customer service representative (“CSR”) would explain the offer and complete the application for the Homeowner. The CSR would then process the application and if approved, the Option documents would be sent out to the Homeowner for execution and payment of the Option Price.

3. Internet—This would be a variation on the telephone sales in which the Homeowner would respond to a mass-media or direct mail advertising campaign by visiting the company's website and completing an online application. The online application would then be processed in basically the same manner as a telephone application and if approved, the Option documents would be sent out to the Homeowner for execution and payment of the Option Price.

4. Option as Part of a New Home Purchase or Refinancing—If the Option is being sold as an add on to a mortgage for the purchase of a new home or the refinancing of an existing home, with a mortgage lender that has been approved by the Originator, the Option Price could be rolled into the amount to be financed by the Loan. As one alternative under which the Homeowner may be able to reduce their mortgage costs (i.e. obtain a lower interest rate to offset the cost of the Option), the Lender may be offered supplemental default protection in the form of a Mortgage Put in conjunction with the Homeowner purchasing an Option. By means of the Mortgage Put, the Lender may sell the Loan to the Surety for the Put Strike Price in the event the Lender records an NOD related to a Mortgage Default.

### General Terms and Conditions of the Option Agreement

Term—The basic term of the Option is expected to be for as long as the Homeowner owns his/her Home, with provisions for early termination in certain circumstances. However, the Homeowner would have the option to reduce the Option Term in order to reduce the Option Price.

Strike Price—The Maximum Strike Price (“MSP”) will be established by the Originator. This price will be determined by current market comps for the Home as well as additional information provided by the Homeowner as part of his/her application. The MSP will typically be 100% of the sales price (for a new purchase) or the price the Home would appraise for at the time the Option is executed. The Homeowner may elect to set the Strike Price below the MSP in order to reduce the Option Price.

Lock-out Period—Each Option will have a Lock-out Period at the beginning of the Option Term during which the Homeowner cannot execute the option to sell contained in the Option. The purpose of the Lock-out Period is to eliminate Homeowners seeking to game the system by selling their Home immediately after executing an Option. The Homeowner may elect to extend the Lock-out Period, if such Homeowner intends on staying in the Home for an extended period of time, in order to reduce the Option Price.

Option Price—As stated above, the Option Price will be determined by the Originator based on its current underwriting requirements. Criteria considered by the Originator in setting the Option Price may include but not be limited to the following:

1. The Option Term;

2. Strike Price (the closer the Strike Price is to the MSP, the higher the risk that the Homeowner may exercise the option);

3. Duration of the Lock-out Period (a longer the Lock-out Period may lower the Option Price);

4. History of local market (e.g. has it historically experienced significant or prolonged market downturns.);

5. Credit score and financial condition of the Homeowner (e.g. does the Homeowner have a high debt ratio or low FICO score increasing the likelihood of a default that would lead to the exercise of the Option);

6. Debt/Equity Ratio for the Home (the higher the debt/equity ratio, the higher the risk that the Homeowner will default on the loan and exercise the Option); and

7. Age/Marital/Career Status of the Homeowner (e.g. the closer the Homeowner is to retirement, the higher the likelihood that the Homeowner will exercise the Option if he/she decides to downsize his/her house during a market downturn).

Reps and Warranties—Because Options may be entered into by the Originator sight unseen, the Option will contain certain standard reps and warranties to be made by the Homeowner including, but not limited to, the following:

1. Home is the primary or secondary residence of Homeowner;

2. Condition of the Home—The Homeowner will rep and warrant that the Home, as of the date of the Option, is in good condition relative to the neighboring properties and that the Homeowner will maintain the Home in such condition during the life of the Option. In addition, the Homeowner will warrant that the Home is free of material defects and will agree to an independent Home inspection at the time the option to sell is exercised to confirm this. Provisions will be included in the Option so that if the Home has material defects at the time the Option is exercised, the Homeowner will have the option of repairing the material defects or accepting a credit against the Strike Price. If the cost of repairs exceeds a certain percentage of the Strike Price (say 20%), the Surety will have the option of terminating the Option and not purchasing the Home.

3. The Home is not being used for any commercial or investment purposes and the Home will not be rented out to third parties during the Option Term.

4. There are no liens or encumbrances against the Home that are known to the Homeowner and not reflected in the preliminary title report (“PTR”).

5. At no time during the Option Term shall the Homeowner allow any encumbrances to be recorded against the Home without the prior written consent of the Surety.

6. If the Homeowner receives any NOD on a loan secured by the Home, the Homeowner shall provide the Surety with written notice within ten (10) business days of receipt of such notice.

If it is determined that there have been any material misrepresentations by the Homeowner or the Homeowner has breached covenants to maintain the Home and not commit waste, the Surety may elect to terminate the Option without purchasing the Home.

Exercise of the Option—A Homeowner shall exercise the Option by providing the Surety with written notice that he/she is exercising the option to sell during the Option Term. The Surety shall have the time specified in the Option contract from the date of receipt of such notice to close escrow on the acquisition of the Home. The Strike Price shall be the sales price of the Home from the Homeowner to the Surety and the closing of escrow shall proceed in accordance with the terms and conditions of the Option.

Exercise of Mortgage Put. If the Lender has a supplemental Mortgage Put and the Homeowner commits a Mortgage Default resulting in the Lender recording and NOD against the Home, the Lender may exercise the Mortgage Put and convey the Loan to the Surety upon the terms and conditions contained in the Mortgage Put. Except for the Mortgage Put Price and the Put Strike Price, the terms and conditions of the Mortgage Put will be substantially similar to those of the Option upon which the Mortgage Put is based. Upon the Surety obtaining the Loan from the Lender, the Surety will attempt to get the Homeowner to exercise the Option but if that fails, may proceed forward with foreclosure or otherwise disposing of the Loan.

Escrow Fees & Costs—The Surety shall have the option of using an independent or affiliated (including a wholly owned subsidiary) company of the Originator as the escrow holder. The escrow holder shall be licensed and/or authorized to do business as an escrow holder in the jurisdiction in which the Home is located. Under the terms and conditions of the Option contract, the escrow holder shall be entitled to collect the higher of (i) the standard escrow fees and related costs typically charged by escrow companies in the local market or (ii) a preset amount or percentage of the sales price established in the Option contract. The escrow fees and costs shall be allocated between the Homeowner and Surety in accordance with local custom and practice.

Title Insurance—The Surety shall have the option of (i) using an independent or affiliated (including a wholly owned subsidiary) company as the title company or (ii) self-insuring. If Originator elects to use a title company (whether independent or affiliated) such title company shall be licensed and/or qualified to do business as a title insurance company in the jurisdiction in which the Home is located. Under the terms and conditions of the Option contract, the title company shall be entitled to collect the higher of (i) the standard title insurance premiums charged by such title company for a comparable title policy or (ii) a preset amount or percentage of the sales price established in the Option contract. If the Originator elects to self-insure, the Originator shall be entitled to collect a premium from the Homeowner that is the higher of the (i) standard premium for a typical residential title insurance home option contract in the local market or (ii) a preset amount or percentage of the sales price established in the Option contract. The title insurance premium, whether paid to a title company or the Originator shall be paid by the Homeowner.

Broker's Commission—The Surety shall have the option of (i) establishing a subsidiary that is a licensed real estate broker in the jurisdiction in which the Home is located, which shall be paid a commission equal in one embodiment to six percent (6%) of the sales price at the close of escrow or (ii) reducing the Strike Price of the Home by six percent (6%) to adjust for the standard real estate broker's commission that would otherwise be paid by the Homeowner if the Home were sold to a third party.

Pro-rations at the Close of Escrow—All allocations and pro-rations between Homeowner and Surety (e.g. property taxes) shall be done in accordance with local custom and practice.

Home Inspection/Disclosures—The Homeowner shall bear all costs related to an independent home inspection as well as the cost of all mandated disclosure reports. Surety shall be entitled to credits against the Strike Price for all costs disclosed by the home inspection in accordance with the terms of the Option contract.

Alternative Products and/or Services in Conjunction With the Present Invention

Inflation Protection—For an additional service fee and a marginal increase of the original Option Price, to be determined by the Originator, the Homeowner may elect to periodically increase the Strike Price to protect any additional appreciation of his/her Home during the Option Term. If such inflation protection is purchased, the Option will be amended to reflect such change to the Strike Price and also may establish a new Lock-out Period with respect to the additional protection.

Home Improvement Protection—For an addition service fee and a marginal increase of the original Option Price, to be determined by the Originator, the Homeowner may elect to increase the Strike Price to protect any additional appreciation of his/her Home during the Option Term resulting from improvements made to the Home. If such home improvement protection is purchased, the Option will be amended to reflect such change to the Strike Price and may also establish a new Lock-out Period with respect to the additional protection.

Home Equity Line of Credit—For an additional fee, during the Option Term, Homeowners shall have the option of establishing a Home Equity Line of Credit (“HELOC”) up to a predetermined percentage of the Strike Price which shall be secured by a deed of trust recorded against the Home. The HELOC must be repaid on or before the termination of the Option Term.

Reverse Mortgage Option—For Homeowners who meet the qualifications for a reverse home mortgage, the Homeowner may elect to exercise the Option in the form of a reverse mortgage as opposed to a straight sale of the Home to Surety. The total value of the reverse mortgage will be based on the industry standard LTV ratio for such mortgages using the adjusted Strike Price contained in the Option as the value of the Home.

Annuity—Insurance companies could offer Homeowners an annuity based on the Homeowner's equity in their home, the minimum value of which would be further secured by an Option.

Financing of Option Price—The Originator may also offer a financing option enabling the Homeowner to pay-off the Option over some agreed upon term if the Homeowner does not wish to include it in his/her mortgage. Under the terms of the financing arrangement, the Option would bear interest at a market rate established by the Originator along with an initiation and administrative fee. If there is any outstanding balance at the time the Option is exercised, the total principal balance plus any outstanding initiation and/or administrative fees and any accrued interest shall be deducted from the Strike Price at the close of escrow.

### Secondary Markets

The Surety will typically invest a portion of the Option Price and Mortgage Put Price in various investment vehicles, including such vehicles that are counter-cyclical to the real estate market. The Surety will earn income from the investments and will use the principal and investment income to fund operations and the purchase of Homes and Loans when Options and Mortgage Puts are exercised, respectively. The Surety may also purchase insurance policies against losses experienced from the exercise of Options or Mortgage Puts or short futures and option contracts based on related real estate market indexes to hedge its risk related to the exercise of Options and Mortgage Puts.

In addition, the Surety may offload some of its portfolio risk by “selling” a basket of Options and/or Mortgage Puts to institutional investors. The institutional investors would receive an agreed upon percentage of the total Option Price or Mortgage Put Price received by the Surety for that portfolio of Options and/or Mortgage Puts in exchange for the institutional investor assuming the risk of exercise of those Options and/or Mortgage Puts within that portfolio. These portfolios of Options and/or Mortgage Puts could then be securitized and traded on a secondary market. The price of each Option and/or Mortgage Put portfolio would then be a function of the historical rates of homeowners exercising Options and Lenders executing Mortgage Puts, current pricing trends within the housing market, and whether the underlying Options and/or Mortgage Puts within a given portfolio are currently “in the money” or “out of the money.” In another alternative, the Surety may purchase re-insurance to mitigate the contingent exercise risk within the portfolio of Options and/or Mortgage Puts.

In one embodiment of the invention, an ultimate goal is to obtain a critical mass of Options and/or Mortgage Puts sufficient to support a secondary market for trading Option and/or Mortgage Put portfolios much the same way mortgage backed securities are currently traded.

The foregoing has described a preferred approach to the present invention. However, various changes and amendments are possible. For example, it is possible that the Option may include some restrictions on exercise (e.g. the Homeowner must move outside a certain radius from the Home being sold). But to the extent this is done, it will most likely be an option to reduce the Option Price for the Homeowner. Because the Option is a put option, it offers several advantages over and above basic equity protection. It offers Homeowners, surety with respect to price, timing and execution of the closing of escrow. In other words, from the time the Homeowner exercises the Option, he/she knows that escrow will close within a predetermined amount of time with no risk that the Surety will not perform. Exercise of the Option also saves the Homeowner from having to actively market his/her Home and allow strangers to enter their Home during the sales process. This security of performance, timing and convenience may motivate some Homeowners to exercise their Option even when the forecasted sales price for the Home may be equal to or slightly more than the Strike Price.

Unlike an insurance policy, the Option is a loss prevention device as opposed to a loss recovery (indemnification) or loss mitigation device. By purchasing an Option, the Homeowner avoids any loss from selling their Home in a down market as opposed to a traditional claims based insurance policy under which the Homeowner would have to go through the entire sales process in order to determine the magnitude of their loss and then turn around and file a claim for recovery of that loss. The Option provides Homeowners with the peace of mind that they will always realize the value for their Home in a straightforward and timely sale, regardless of market conditions.

Other modifications and improvements may be made without departing from the scope of the invention.

1. A method of preventing a decline in market value for a particular piece of real property during a term, comprising the steps of:
providing an owner of real property with a unilateral option to sell such real property to a designated buyer (the “surety”);
defining a strike price (the gross price at which the real property will be purchased);
defining a term for exercising the option to sell;
defining a purchase price for the option;
defining a lock-put period during which the option holder cannot exercise the option;
providing a guarantee that the real property will be purchased by the surety at the strike price during the term.

2. A method as defined in claim 1, wherein the step of providing a unilateral option to the owner of the real property to sell the real property to a surety comprises guaranteeing that the real property will be purchased by the surety at any time during the term upon receipt of a demand from the owner of the real property.

3. A method as defined in claim 2, wherein the real property owner's unilateral option to sell the real property may not be exercised during a predetermined period of time at the beginning of the term.

4. A method as defined in claim 1, wherein the method further comprises the step of the surety purchasing the real property upon receipt of a demand.

5. A method as defined in claim 2, wherein the guarantee includes a promise of the surety to purchase the real property within a predetermined amount of time after receiving the demand.

6. A method as defined in claim 2, wherein the guarantee includes a promise for the surety to purchase the real property for the strike price.

7. A method as defined in claim 1, wherein the term is for as long as the owner of the real property owns the property, or any term less than that at the election of the owner.

8. A method as defined in claim 1, wherein the strike price is the equivalent price at which the real property would appraise or sell for at the time the option is provided, or any price less than that at the election of the owner.

9. A method as defined in claim 1, wherein the lock-out period is for one year at the beginning of the term, or any longer or shorter term at the election of the Surety or the owner.

10. A method as defined in claim 1, wherein the unilateral option to sell is renewable.

11. A method as defined in claim 1, wherein the option fee is a function of the length of the term.

12. A method as defined in claim 1, wherein the option fee is a function of a difference between the strike price and the price at which the real property would appraise or sell for when the option is provided.

13. A method as defined in claim 1, wherein the option fee is a function of the duration of the lock-out period.

14. A method as defined in claim 1, wherein the option fee is a function of the debt/equity ratio for the real property.

15. A method as defined in claim 1, wherein the option fee is a function of local market history.

16. A method as defined in claim 1, wherein the option fee is a function of the demographics of the local market.

17. A method as defined in claim 1, wherein the option fee is a function of a credit score of the owner of the real property.

18. A method as defined in claim 1, wherein the option fee is a function of the financial history of the owner of the real property.

19. A method as defined in claim 1, wherein the option fee is a function of the employment/working status of an owner of the real property.

20. A method as defined in claim 1, wherein the option fee is a function of the marital status of the owner of the real property.

21. A method as defined in claim 1, wherein the option fee is a function of the age of the owner of the real property.

22. A method as defined in claim 1, wherein the property has an owner and the method includes requiring the owner to make one or more of the following warranties:
the property is a primary or secondary residence of the owner;
that the property is in good condition;
that the owner shall maintain the property in good condition and shall not commit waste or defer necessary maintenance;
that the property will be used only for non-commercial purposes;
that the property is not subject to and liens or encumbrances that would not be identified on a current preliminary title report;
that encumbrances on the property will not exceed a predefined percentage of strike price; and
that the owner of the real property will not further encumber the property without the express written consent of the surety.

23. A method as defined in claim 1, wherein the method includes a step of adjusting the strike price to compensate for costs of selling the property.

24. A method as defined in claim 1, wherein the method includes a step of adjusting the strike price to compensate for costs of repairs.

25. A method as defined in claim 1, wherein the method includes a step of adjusting the strike price to compensate for a broker's commission.

26. A method as defined in claim 1, wherein the method further includes a step of providing the owner with a home equity line of credit for up to a percentage of the strike price.

27. A method as defined in claim 1, wherein the method includes providing an option for payment to the owner in a form of a reverse mortgage.

28. A method as defined in claim 27, wherein the reverse mortgage is based on the strike price of the option.

29. A method as defined in claim 1, wherein the method includes charging a fee in return for providing the real property owner with the unilateral option to sell.

30. A method as defined in claim 29, wherein the fee is to be paid over time.

31. A method as defined in claim 1, wherein the method includes investing at least a portion of the option fee in investment vehicles.

32. A method as defined in claim 1, wherein the investment vehicles comprise investment vehicles that may be counter-cyclical to a real estate market.

33. A method as defined in claim 1, wherein the method includes recording a deed of trust against the property.

34. A method as defined in claim 1, wherein the method includes a step of offering to pay for the property by way of a reverse mortgage.

35. A method of insuring real property against a decline in market value during a term, comprising the steps of:
receiving a guarantee from an insurer that the insurer will purchase the real property at an established price at any time during a predefined term upon receipt of a demand;
paying an option fee in exchange for the guarantee; and
exercising an option to sell the real property at the established price during the predefined term.

36. A method of insuring real property against a decline in market value during a term, comprising the steps of:
defining a purchase price;
defining a term;
providing a guarantee that an insurer will purchase the real property at the purchase price at any time during the term upon receipt of a demand from an insured;
paying an option fee in exchange for the guarantee; and
exercising an option to sell the real property at the purchase price during the predefined term.

37. A method as defined in claim 1, wherein the obligations of the surety may be bundled into a portfolio for sale in the secondary market to investors in exchange for a portion of the option fee.

38. A method as defined in claim 1, wherein the surety may assume the mortgage loan of the owner of the real property upon the purchase of such real property.

39. A method as defined in claim 1, wherein the owner may assign his/her right to exercise the option to the mortgage lender in the event that such lender records a notice of default under the terms and conditions of the mortgage loan.

40. A method as defined in claim 1, wherein the owner of the real property may, during the term, elect to increase the strike price because of a rise in property values, by paying an additional option fee for the increased protection.

41. A method as defined in claim 1, wherein the owner of the real property may, during the term, elect to increase the strike price because of improvements made to the real property resulting in an increase of its value, by paying an additional option fee for the increased protection.

42. A method as defined in claim 1, wherein the owner of the real property may, during the term, assign or transfer the option subject to the consent of the surety.

43. A method as defined in claim 1, wherein the option may be offered for sale to owners of real property directly through direct mail, toll free phone numbers and the internet.

44. A method as defined in claim 1, wherein the option may be offered for sale to owners of real property through a network of agents.

45. A home option contract for protecting real estate against a decline in value of a home, comprising:
an established strike price;
a term; and
a guarantee, wherein the guarantee ensures that the real property can be purchased at the established strike price during the term.

46. The home option contract of claim 45, further comprising a demand, wherein the guarantee ensures that the real property can be purchased at any time during the term upon receipt of a demand.

47. The home option contract of claim 46, wherein the guarantee includes a promise to purchase the property within a predetermined amount of time after receiving the demand.

48. The home option contract of claim 45, wherein the strike price is less than the price at which the property would appraise at the time the guarantee is provided.

49. The home option contract of claim 45, further comprising an option fee which is a function of a difference between the strike price and an appraisal price when the guarantee is provided.

50. The home option contract of claim 45, wherein the option fee is a function of one or more of local market history, a credit score, a financial history, a debt/equity ratio for the real property or career status of an owner of the real property.

51. The home option contract of claim 45, wherein the strike price is adjustable to compensate for one or more of costs of selling the real property, costs of repairs, or broker's commission.

52. The home option contract of claim 45, further comprising a home equity line of credit up to a percentage of the strike price.

53. The home option contract of claim 45, further comprising a reverse mortgage option.

54. The home option contract of claim 45, further comprising an investment vehicle that is counter-cyclical to a real estate market.
